(19) United States
(12) Patent Application Publication
(10) Pub. No.: US 2015/0160800 A1
(43) Pub. Date: Jun. 11, 2015

(54) DISPLAY DEVICE, ELECTRONIC DEVICE AND PROGRAM

(71) Applicant: KABUSHIKI KAISHA TOSHIBA, Tokyo (JP)

(72) Inventors: Kazuki Kuwahara, Saitama Saitama (JP); Masami Tanaka, Ome Tokyo (JP)

(21) Appl. No.: 14/624,132

(22) Filed: Feb. 17, 2015

Related U.S. Application Data
(63) Continuation of application No. PCT/JP2013/080541, filed on Nov. 12, 2013.

(51) Int. Cl. G06F 3/0482; G06F 3/0484

(52) U.S. Cl. CPC G06F 3/0482; G06F 3/04845

(57) ABSTRACT

According to a method of adjusting a display of a display apparatus, a first menu including a first group of an adjustment item and value is superimposed on an image displayed on a display module. A menu file made in markup language to indicate a second menu is transmitted to an external apparatus in response to a transfer request given from outside, the second menu including at least the first group of the adjustment item and value. A response file is output from the external apparatus based on transmission of the menu file, which includes the display adjustment item and value set in the second menu, and displaying of the image is adjusted in accordance with the set display adjustment item and value in the response file.

### CROSS REFERENCE TO RELATED APPLICATIONS

This application is a Continuation Application of PCT Application No. PCT/JP2013/080541, filed Nov. 12, 2013, the entire contents of which are incorporated herein by reference.

### FIELD

Embodiments described herein relate generally to image adjustment of an image display device.

### BACKGROUND

A conventional image display device, for example, a conventional television receiver, displays on its screen, a setting menu indicating an adjustment item of an image and audio and degrees of an adjustment (an adjustment value) with on-screen display (OSD), and the adjustment value are set by operating buttons provided at a main body or a remote control.

In a conventional image display device, a setting menu is superimposed on an image displayed on a screen. Thus, even if an image is changed by changing adjustment values, the change cannot be easily visibly recognized. Inevitably, setting cannot be easily performed. Furthermore, in order that the values be adjusted, they are each changed by a fixed value at a time by giving an instruction with a button. Thus, it is not easy to greatly or finely change the value.

Furthermore, it is hoped that with respect to each of picked-up images, especially, pictures, adjustment values could be set, and once an actual image (actual picture) is set, it could be repeatedly displayed in the same adjustment state.

Also, it is hoped that once an actual image (actual picture) is finely set in a given image display device (monitor), even if any image display device (monitor) is applied, it could reproduce an image (picture) identical to the actual image (actual picture) at the same adjustment value as in the actual image (actual picture).

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view showing an example of a system configuration according to an embodiment;

FIG. 2 is a view showing an example of a configuration of a monitor apparatus in the embodiment;

FIG. 3 is a view showing an example of a configuration of a personal computer in the embodiment;

FIG. 4A is a view showing an example of an image displayed by the monitor apparatus in the embodiment;

FIG. 4B is a view showing an example of a main menu superimposed on the displayed image in the embodiment;

FIG. 5 is a flowchart showing an example of image adjustment processing with an HTML menu in the embodiment;

FIG. 6A is a view showing an example of an image displayed on a display of the personal computer in the embodiment;

FIG. 6B is a view showing the example of the HTML menu in the embodiment, which is provided as shown in FIG. 6A;

FIG. 7A is a view showing part of a hierarchical structure of another example of the HTML menu in the embodiment;

FIG. 7B is a view showing another part of the hierarchical structure of the above other example of the HTML menu in the embodiment;

FIG. 7C is a view showing still another part of the hierarchical structure of the above other example of the HTML menu in the embodiment;

FIG. 7D is a view showing a further part of the hierarchical structure of the above other example of the HTML menu in the embodiment;

FIG. 7E is a view showing a still further part of the hierarchical structure of the above other example of the HTML menu in the embodiment;

FIG. 8 is a view showing a format of set value data for display adjustment of the monitor apparatus, which is saved in the personal computer as shown in FIG. 3;

FIG. 9 is a flowchart showing an example of saving processing of a set file with the HTML menu in the embodiment;

FIG. 10 is a flowchart showing an example of restoration processing of the set file with the HTML menu in the embodiment; and

FIG. 11 is a view showing an example of a system configuration according to a modification of the embodiment, in which a plurality of monitor apparatuses are caused to display the same adjusted image.

### DETAILED DESCRIPTION

Embodiments described herein provide a program, a method and an electronic device including a user interface which facilitates setting of various adjustments of an image display device.

According to an embodiment, there is provided a display apparatus which comprises an input mode which inputs an image signal from outside, a display module which displays an image based on the image signal, and the image adjustment module which adjusts the image displayed by the display module. The display apparatus further comprises a storage module which stores a first menu and a second menu, each of which is to superimposed on the image in response to a display instruction to instruct the image adjustment module to display an adjustment menu, the first menu including a first group of an adjustment item and an adjustment value, the second menu including a second group of a display adjustment item and an adjustment value. The second group of the display adjustment item includes at least the first group of the adjustment item and the second group of the display adjustment value includes at least the first group of the adjustment value, wherein the second menu is stored as a menu file made in markup language in the storage module. A transmitter-receiver is provided in the display apparatus, wherein the transmitter-receiver transmits the menu file from the storage module to an external electronic apparatus in response to a transfer request from outside, and receives a response file which is output from the external apparatus based on transmission of the menu file, and which includes set the display adjustment item and the adjustment value set in the second menu. The display apparatus furthermore comprises a controller which causes the image adjustment module to adjust the image in accordance with the set display adjustment item and the set adjustment value in the response file.

According another embodiment, there is provided an electronic apparatus connectable to a display apparatus which comprises an image adjustment module which adjusts a displayed image, and a storage module which stores a first menu and a second menu, the first menu including a first group of an adjustment item and an adjustment value, the second menu including a second group of an adjustment item and an adjustment value and being also stored as a file made in markup language. The electronic apparatus comprises a reception module which receives the file from the display apparatus, and a display module which displays the second menu based on the file received by the reception module and a transmission module which transmits the adjustment value set based on the second group of the adjustment item and the adjustment value included in the menu, as a response file, to the display apparatus, and causes the image adjustment module to adjust the image in accordance with the set display adjustment item and the set adjustment value. The electronic apparatus further comprises a storage module which stores the set display adjustment item and the set adjustment value in association with the image associated with the image displayed by the display module.

A first embodiment will be explained with reference to the accompanying drawings.

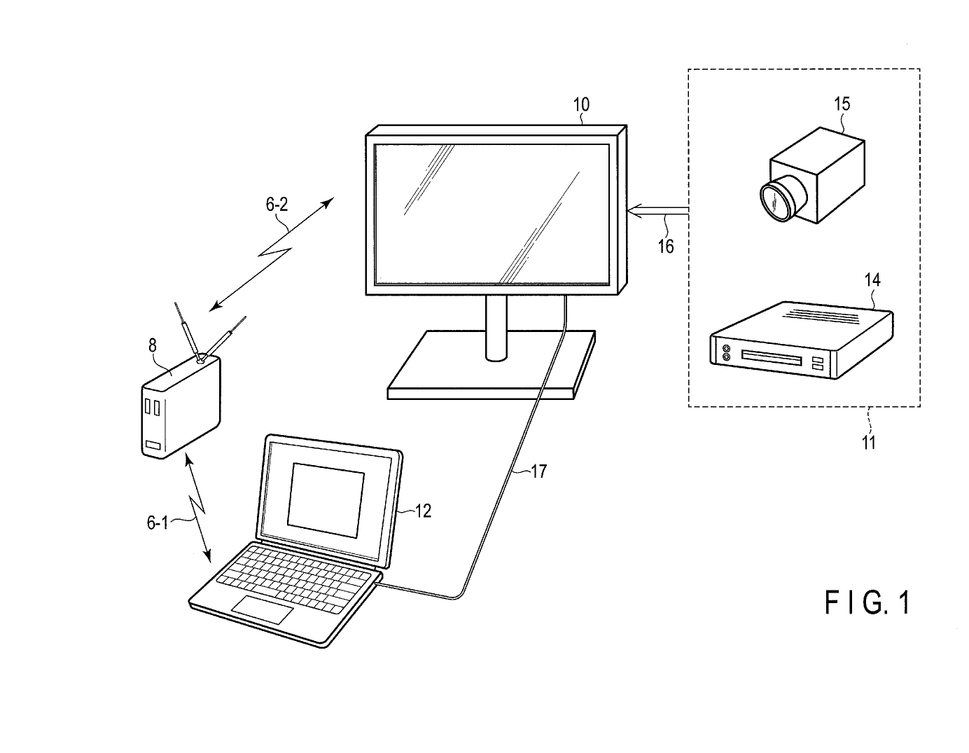

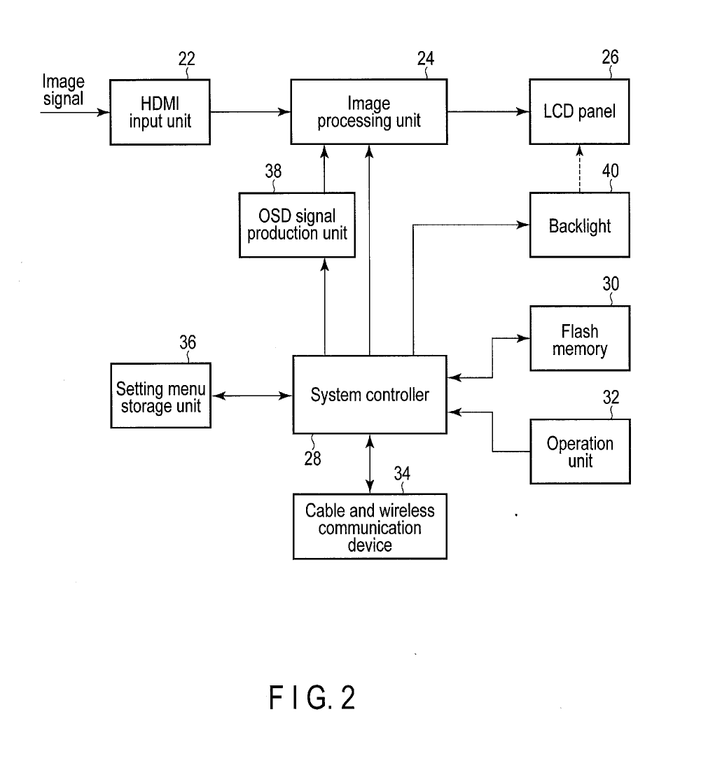

FIG. 1 is a view showing a system configuration of a system according to the first embodiment. The system comprises a monitor apparatus 10 formed of an LCD panel or the like, a tablet type personal computer (hereinafter referred to as a personal computer) 12, and an image source device 11. As it is not shown, at a frame portion of a front surface, a side surface or a rear surface of the monitor apparatus 10, operation buttons are provided as an operation module 32 as shown in FIG. 2. The operation buttons includes a plurality of buttons such as menu buttons, up and down buttons, left and right buttons, or a cruciform button whose upper, lower, left, right and center portions can be pressed or a double button (in which an annular button is provided on an outer side of the double button such that its upper, lower, left and right portions can be pressed). The menu buttons are buttons for giving an instruction to display an adjustment menu, and are also provided to cause a setting menu for image adjustment to be displayed, the setting menu including a first group of adjustment items and adjustment values. The menu buttons include up and down buttons for use in selecting an item in a menu, and left and right buttons for use in selecting a value of the item. However, as described later, in the first embodiment, a setting menu is displayed on a screen of the personal computer 12, and an item and an item value are selected on the screen. Thus, if an instruction to display the adjustment menu can be given from the personal computer 12, the operation buttons of the monitor apparatus 10 can be omitted. Alternatively, a simple setting menu having a small size is displayed by the monitor apparatus 10, and a complicated setting menu having a large size is displayed by the personal computer 12.

It should be noted that a main menu (menu for monitor) to be displayed by the monitor apparatus 10 is a simple setting menu having a small size which is limited regarding display items and adjustment values. The simple setting menu is set as a specific menu for the monitor apparatus 10, which is not displayed in a display module of the personal computer 12. If the personal computer 12 issues a request for transmission of an HTML menu which is a detailed adjustment menu, and the monitor apparatus 10 displays the detailed adjustment menu, the simple setting menu displayed by the monitor apparatus 10 is dismissed when the detailed adjustment menu is displayed. It should be noted that the detailed adjustment menu includes at least a first group of adjustment items and adjustment values, and also a includes second group of adjustment items and adjustment values which are obtained by adding another or other adjustment items and another or other adjustment values to the first group of adjustment items and adjustment values.

The image source device 11 is a device which supplies an image signal to the monitor apparatus 10, and includes a camera device 15, a TV tuner, a DVD (registered trademark)/BD (registered trademark) player 14, a set-top box, etc. The image source device 11 and the monitor apparatus 10 are connected to each other by a cable 16 conforming to image display standards of a display port or a High-Definition Multimedia Interface (HDMI) monitor port. HDMI Standards include, for example, HDMI 1.4 and HDMI 2.0.

The personal computer 12 is connected to the monitor apparatus 10 by a wireless LAN (e.g., IEEE802) using an access point 8 or a cable LAN. To be more specific, the personal computer 12 may be directly connected to a LAN port of the monitor apparatus 10 by a LAN cable (not shown). Alternatively, it may be set that the personal computer 12 is connected to the access point 8 by a wireless LAN 6-1, and the access point 8 is connected to the LAN port of the monitor apparatus 10 by a wireless LAN 6-2 or a LAN cable (not shown). Furthermore, in order to output an image signal to the monitor apparatus 10, the personal computer 12 is connected to a monitor port of the monitor apparatus 10 by a video cable, e.g., an HDMI cable 17.

It should be noted that the monitor apparatus 10 and the image source device 11 do not need to be physically separated from each other; that is, in the first embodiment, a television receiver may be provided as a combination of the monitor apparatus 10 and the image source device 11. The personal computer 12 receives a setting menu image for image adjustment, from the monitor apparatus 10, and causes the setting menu image to be displayed by a web browser.

However, in a TV mode in which a TV signal is input to the monitor apparatus 10, and a TV image is displayed, or a movie mode in which an image such as a movie is displayed, image adjustment cannot be performed after calibration, and an image is displayed in a default image setting determined in a predetermined TV/movie mode.

FIG. 2 is a block diagram showing a system configuration of the monitor apparatus 10. An image input module (e.g., HDMI input module) to which an image signal is to be inputted from the image source device 11 is connected to an image processing module 24. The image processing module 24 adjusts an image signal with respect to various items (for example, contrast, black level, gamma characteristic, coloring, color strength and sharpness), and is supplied with set values of adjustment items by a system controller 28. The system controller 28 includes a CPU. An output of the image processing module 24 is displayed by an LCD panel 26. The system controller 28 is connected to a flash memory 30 which stores the set values of the adjustment items, the operation module 32, a cable and wireless communication device 34 which communicates with the personal computer 12, a setting menu storage module 36, an OSD signal production module 38, a backlight 40, etc. The system controller 28 sets the set values read from the flash memory 30 in the image processing module 24. The flash memory 30 also stores software (firmware) for controlling an operation of the system controller 28 including the CPU. The operation module 32 includes the above operation buttons provided at the frame portion of the front surface, the side surface or the rear surface of the monitor apparatus 10. The setting menu storage module 36 stores a file in which a setting menu image (prepared in advance) regarding adjustment values for use in adjusting the image signal with the image processing module 24 is described in markup language (for example, Hypertext Markup Language [HTML]). As explained above, the setting menu image includes a simplified main menu which is formed by two kinds of HTML files and to be displayed on an LCD panel 26 of the monitor apparatus 10 and a detailed adjustment menu which is sent to the personal computer 12 through a wireless communication device 34 and displayed on a display panel of the personal computer 12. Also, as explained above, if data of the detailed adjustment menu is transferred from the monitor apparatus 10 to the personal computer 12 in response to a request for transfer of an HTML menu, a simplified setting menu displayed by the monitor apparatus 10 is dismissed by a control by the system controller 28, and only an image to be adjusted, which is a background image, is displayed by the monitor apparatus 10. The simplified main menu and the detailed adjustment menu are stored in the setting menu storage module 36.

The OSD signal production module 38 makes a main menu to be displayed on the LCD panel 26 by on-screen display (OSD). An output of the OSD signal production module 38 is supplied to the image processing module 24, and the main menu is superimposed on an image to be adjusted such as a picture. As described above, the main menu can be omitted. If it is omitted, the OSD signal production module 38 can also be omitted. The system controller 28 also controls brightness and color temperature of the backlight 40.

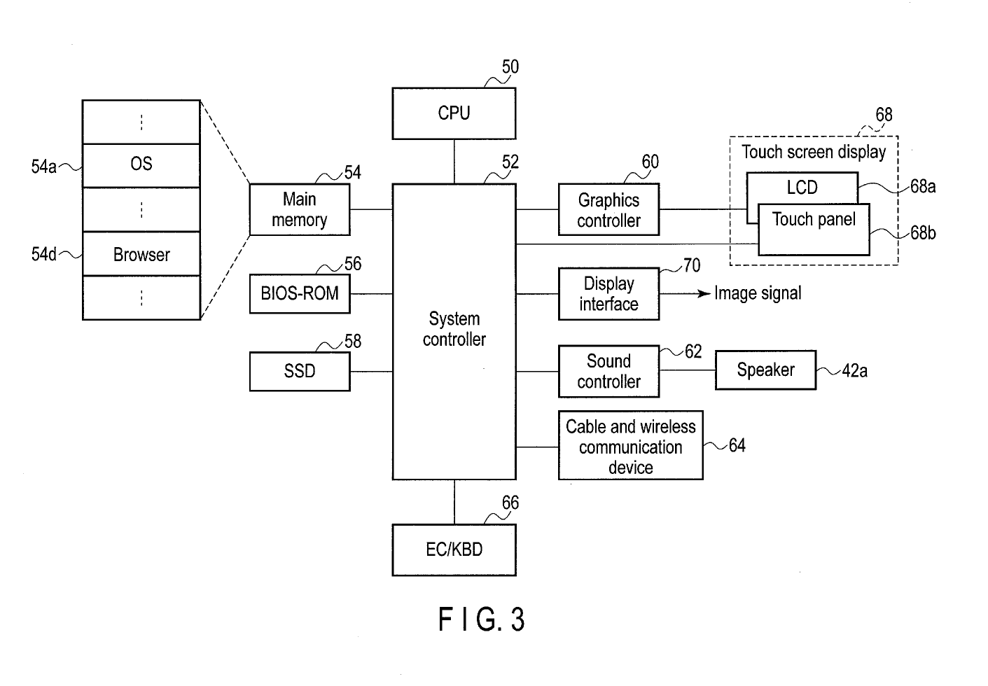

FIG. 3 is a block diagram showing a system configuration of the personal computer 12. The personal computer 12 comprises a CPU 50, a system controller 52, a main memory 54, a BIOS ROM 56, a solid-state drive (SSD) and/or hard disk drive (HDD) 58, a graphics controller 60, a sound controller 62, a wireless communication device 64, an embedded/keyboard (EC/KBD) controller 66, a touch screen display 68, a port, e.g., an HDMI port and/or display port, a display interface 70 which outputs an image signal through the port, etc.

The CPU 50 is a processor which controls operations of various modules provided in the personal computer 12. The CPU 50 executes software loaded from an SSD 58, which is a nonvolatile storage device, into the main memory 54, and as the software, various kinds of software can be applied. The software includes an operating system (OS) 54a, a browser 54d, etc.

The browser 54d causes an HTML menu image to be displayed by the touch screen display 68 based on an HTML file which is sent from the wireless communication device 34 of the monitor apparatus 10, and received by the wireless communication device 64.

The CPU 50 also executes a basic input output system (BIOS) stored in the BIOS ROM 56. The BIOS is a program for controlling hardware.

The system controller 52 is an interface which connects the CPU 50 and various components. The system controller 52 incorporates a memory controller not shown which controls an access to the main memory 54. To the system controller 52, the main memory 54, the BIOS ROM 56, the SSD and/or hard disk drive (HDD) 58, the graphics controller 60, the sound controller 62, the wireless communication device 64, the EC/KBD controller 66, a display interface 70, etc., are connected.

The graphics controller 60 controls an LCD 68a serving as a display monitor of the personal computer 12. The graphics controller 60 transmits a display signal to the LCD 68a under a control by the CPU 50. The LCD 68a displays a screen image based on the display signal. At a display surface of the LCD 68a, a touch panel 68b is provided. It should be noted that the monitor of the personal computer 12 is not limited to the touch screen display 68, and an ordinary monitor formed of LCD 68a may be applied as the monitor of the personal computer 12. In this case, an item in the HTML menu and a value of the item can be selected using a mouse or the like.

The sound controller 62 is a controller which processes an audio signal or an alarm, and produces an audio signal or an alarm to be output from a speaker 42a. The alarm is given, for example, in the case where an operation is not correctly performed.

The cable and wireless communication device 64 is configured to execute communication with another device through a LAN cable, and also wireless communication such as wireless LAN or 3G mobile communication or near field wireless communication such as near field communication (NFC). With the cable and wireless communication device 64, the personal computer 12 is connected to the monitor apparatus 10.

The EC/KBD controller 66 is a one-chip microcomputer in which an embedded controller and a keyboard controller are packed, the embedded controller being provided to perform a power control, the keyboard controller being provided to control a keyboard. The EC/KBD controller 66 also includes a panel controller which controls the touch panel 68b. The EC/KBD controller 66 has a function of powering up and down the personal computer 12 in accordance with an operation of a power supply button not shown.

Next, image adjustment according to an embodiment will be explained.

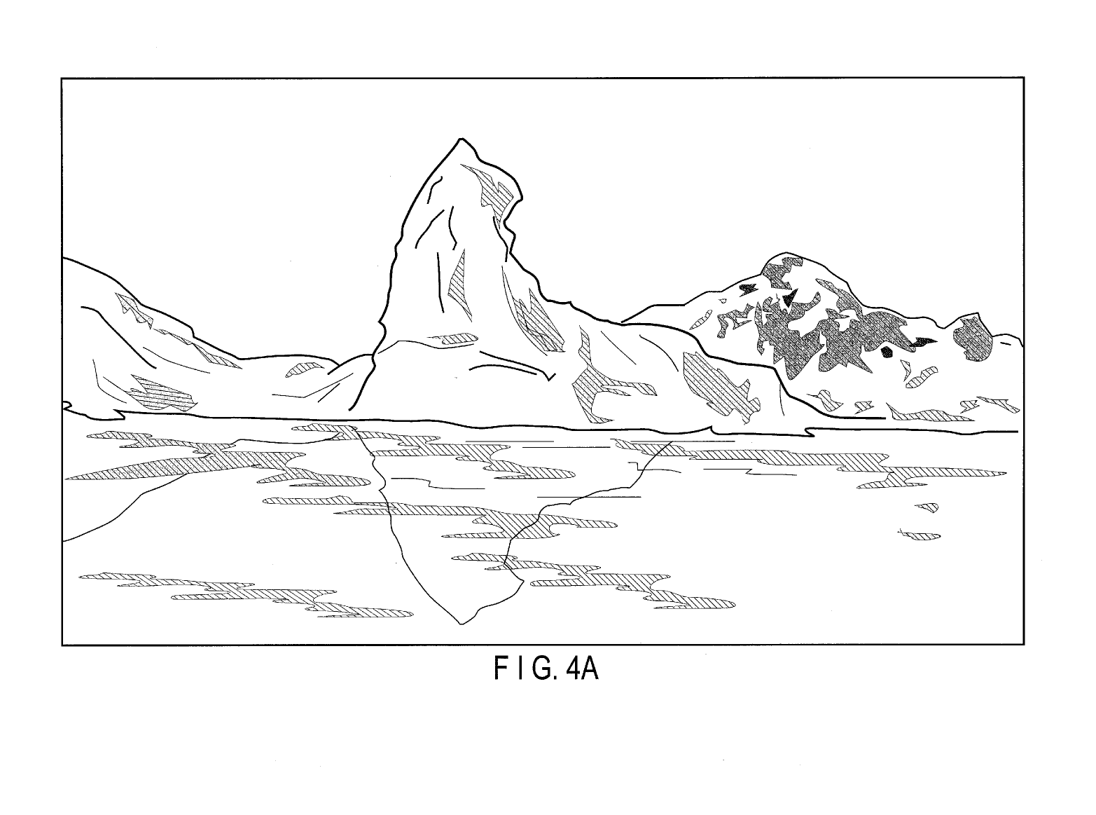

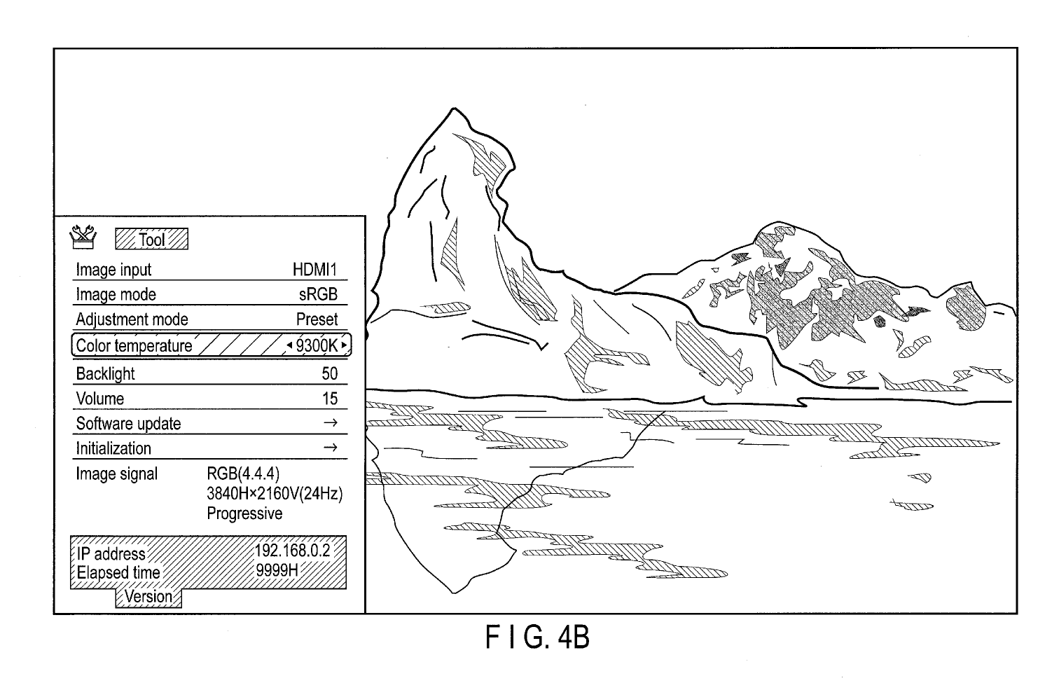

Of operation buttons of the monitor apparatus 10, if a menu button, a center key of a cruciform button or a center key of a double-button is pressed, while an image to be adjusted is being displayed by the monitor apparatus 10 as shown in FIG. 4A, the main menu is superimposed on the image by the OSD as shown in FIG. 4B. In this state, if the menu button or the like is re-pressed, the menu is dismissed, and only the above image, i.e., a background image as shown in FIG. 4A, is displayed by the monitor apparatus 10.

It should be noted that although the main menu is superimposed on the background image, the image is not limited to the above image to be adjusted. The image to be adjusted may be selected afterward. Also, as the background image, an image prepared in advance in a memory in the monitor apparatus 10 may be applied, or an image for adjustment which is supplied from the image source device 11 or the personal computer through cables 16 and 17 for HDMI or the like may be applied.

The main menu includes, for example, the items “Image input”, “Image mode”, “Adjustment mode”, “Color temperature”, “Color temperature”, “Backlight”, “Volume of headphones”, “Software (firmware) update”, “Initialization”, “Format indication of image signal being input”, “Indication of IP address of device”, “Indication of elapsed time from execution of calibration” and “Indication of version of software”. Any of the items is selected with a cursor which is moved by pressing an up or down key. After the cursor reaches the uppermost item, if the up key is further pressed, the cursor is moved to the lowermost item. Similarly, after the cursor reaches the lowermost item, if the down key is further pressed, the cursor is moved to the uppermost item. In such a manner, the up and down keys cause the cursor to be moved in a manner of loop operation.

For example, selection of each of the items is performed as follows. The image input is set to one of “HDMI 1”, “HDMI 2” and “Display port”. The image mode is set to one of “Adobe RGB”, “RGB”, “BT. 709”, “EBU”, “SMPTE-C”, “DICOM-sim”, “Television” and “Movie”. The adjustment mode is set to one of “Preset” and “Custom”. The color temperature is set to fall within the range of 4,000 to 15,000 K while being changed in increments or decrements of 100 K. The backlight is set to fall within the range of 40 to 350 cd/m² while being changed in increments or decrements of 10 cd/m² (only in a manual setting).

The volume of the headphones is set to fall within the range of 0 to 100 while being changed in increments or decrement of 5 (it can be adjusted when a headphones terminal is used). “Software (firmware) update” and “Initialization” are each set to one of “Execution” and “Non-execution”. “Format of image signal”, “IP address”, “Elapsed time after execution of calibration” and “Version of software” are automatically displayed. It should be noted that “Calibration” is a color calibration, and is automatically performed when a sensor connected to a USB terminal of the monitor apparatus 10 is brought into intimate contact with the LCD panel 26 to measure brightness and color.

A choice (item value) of each item is selected by pressing a left or right key. Also, the left and right keys, as well as the up and down keys, may be set to cause the cursor to be moved in the manner of loop operation. However, with respect to selection of an item value, there is a case where preferably, the cursor should not be moved in the manner of loop operation. Whether to move the cursor in the manner of loop operation or not is determined arbitrarily.

In such a manner, by operating operation buttons of the monitor apparatus 10, the main menu is superimposed on the image by the OSD, and an item and an item value are selected by operation of operation buttons, thereby selecting an image adjustment value.

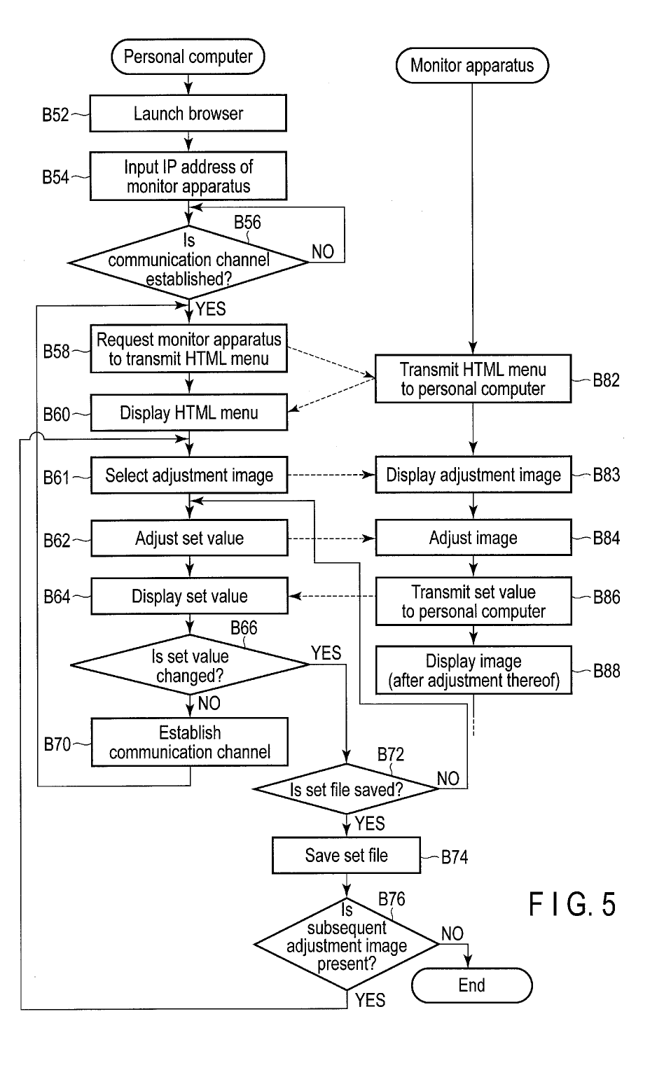

Next, it will be explained with reference to a flowchart of FIG. 5 how an image adjustment is set by performing a tapping operation and a slide operation on the touch screen display 68 of the personal computer 12 or by operating the mouse over the monitor of the personal computer 12, after the menu image is displayed by the personal computer 12 while an image is being displayed by the monitor apparatus 10.

In block B52, in the personal computer 12, a browser is launched, with a background image displayed by the monitor apparatus 10 as shown in FIG. 4A. In block B54, an IP address of the monitor apparatus 10 is input as URL (http://IP address of the monitor apparatus). The IP address of the monitor apparatus 10 can be confirmed in the main menu since it is displayed therein. Instead of inputting the IP address, it may be set that a detailed adjustment menu is registered as a home image in the personal computer 12 or added as a favorite, whereby it can be used without re-inputting the IP address.

When the IP address of the monitor apparatus 10 is input as a URL, the personal computer 12 establishes a communication channel to the monitor apparatus 10. It is confirmed that the communication channel is established (yes in block B56). Thus, the monitor apparatus 10 is requested to transmit an HTML file of the setting menu image, which is stored in the setting menu storage module 36 (block B58). The monitor apparatus 10 transmits the HTML file and set values of various adjustment items stored in the flash memory 30 to the personal computer 12 (block B82). It should be noted that the set values stored in the flash memory 30 may be reset to initial values at the time of powering down the monitor apparatus 10.

The personal computer 12 displays an HTML menu based on the HTML file and set values received from the monitor apparatus 10 (block B60). In the case of changing a presently displayed background image after the HTML file is displayed, an image to be adjusted is selected as another image (not shown). Also, in the case where the presently displayed background image is not changed, i.e., it is selected, an indication to the effect that the image to be adjusted is the presently displayed background image is selected (block B61). Upon determination of the selected image, an image signal for the selected image is input from a display interface 70 of the personal computer 12 to an input module 10 of the monitor apparatus 10, e.g., an HDMI input module 10, and displayed on the display 68 of the monitor apparatus 10. If the selected image is input, displaying of the main menu is stopped, and only a selection image for image adjustment is displayed on the display 68 of the monitor apparatus 10 (block 83).

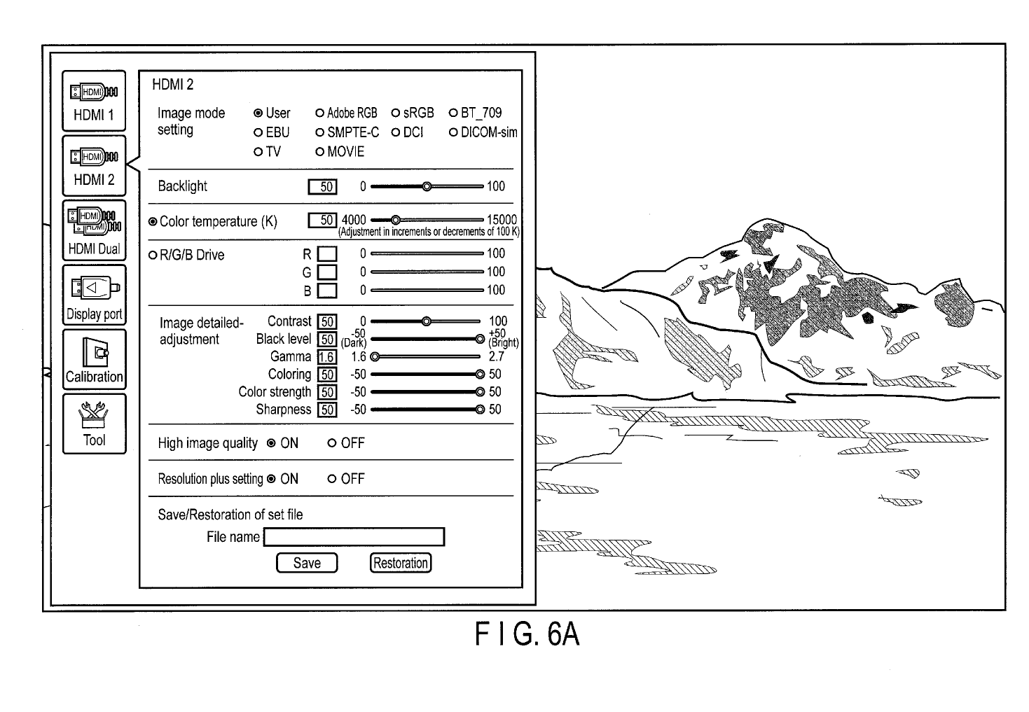

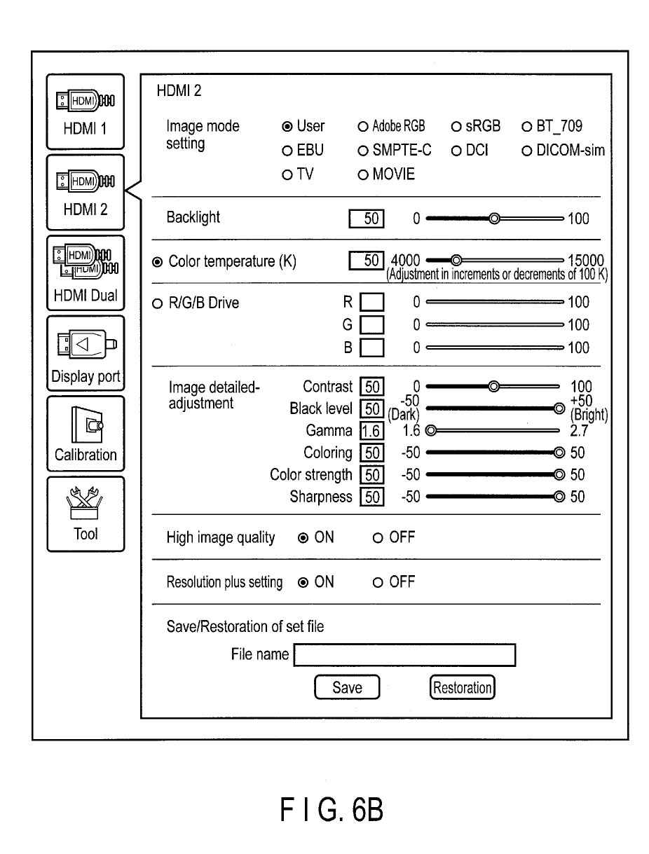

An example of the HTML menu is shown in FIGS. 6A and 6B. In the HTML menu, on a left side, three icons (“HDMI 1”, “HDMI 2” and “HDMI dual”) for use in selecting an image input port, an icon for use in selecting a calibration of another menu and an icon for use in selecting a tool are arranged vertically. Those icons are each selected when being tapped or clicked with the mouse on the touch panel 68b. A menu image for each of image input ports is displayed. In the detailed menu image, if the personal computer 12 is connected to a port for HDMI 2 in the monitor apparatus 10 by the HDMI cable 17, an adjustment menu regarding an image transmitted to the port for HDMI 2 is displayed without an instruction of displaying the adjustment menu. In the detailed menu image, if “HDMI 1” or “Display port” is selected, an image supplied from a device connected to HDMI 1 or display port, for example, the image source device 11, is displayed by the monitor apparatus 10, and an adjustment menu regarding the image supplied from the device connected to the display port is displayed. Also, if “HDMI Dual” is selected, two images transmitted to HDMI 1 and HDMI 2 are dividedly displayed by the monitor apparatus 10, and two adjustment menus regarding images supplied from two devices connected to ports of HDMI 1 and HDMI 2 are displayed. It should be noted that in the case where an image supplied from an external device other than the personal computer 12 is displayed, it is preferable that in selection of an adjustment image in block B61, an image supplied from the external device, e.g., the image source device 11, be transferred to the personal computer 12 through a cable or wireless LANs 6-1 to 6-4.

The following is an explanation of the case where HDMI 2 to which the personal computer 12 is connected is selected in the detailed menu. An HMTL menu includes, for example, the items “Image mode”, “Backlight”, “Color temperature”, “RGB Drive”, “Image detailed adjustment”, “High image quality” and “Resolution plus”.

Choices of the items are, for example, the following. “Image mode” is set to one of “User”, “sRGB”, “BT. 709”, “EBU”, “SMPTE-C”, “DCI”, “DICOM-sim”, “Television” and “Movie”. A choice to be displayed is selected when being tapped or clicked (hereinafter referred to as “tapped”). In such a manner, since an item and an item value can be selected by single tapping, the operability is improved. A button operation which is performed as in that in the main menu needs two selections, i.e., a selection of an item and that of an item value.

In each of the items “Backlight”, “Color temperature”, “RGB Drive” and “Image detailed-adjustment”, a slider is displayed, and a value can be set by moving the slider. It is therefore easy to greatly change the value or finely adjust it. In the case of changing the RGB Drive, the slider is displayed by checking a check box of each of “R”, “G” and “B”; and the brightness of each of R, G and B can be adjusted by moving the slider leftwards or rightwards. “Backlight” is set to fall within the range of 50 to 100 cd/m², while being changed in increments or decrements of 10 cd/m². “Color temperature” is set to fall within the range of 4,000 K to 15,000 K, while being changed in increments or decrements of 100 K. “RGB Drive” is set to fall within the range of 0 to 100% with respect to each of R, G and B. It should be noted that “RGB Drive” cannot be set to 30% or less with respect to the total value of “R”, “G” and “B”. Also, “Color temperature” and “RGB Drive” are independent of each other. “Image detailed-adjustment” includes the items “Contrast”, “Black level”, “Gamma”, “Coloring”, “Color strength” and “Sharpness”. “Contrast” is set to fall within the range of 0 to 100 while being changed in increments or decrements of 10; “Black level” is set to fall within the range of −50 (dark) to +50 (light) while being changed in increments or decrements of 10; “Gamma” is set to fall within the range of 1.6 to 2.7 while being changed in increments or decrements of 0.1; and “Coloring”, “Color strength” and “Sharpness” are each set to fall within the range of −50 to +50 while being changed in increments or decrements of 10. “High image quality” and “resolution plus” are each set to “ON” or “OFF”.

In the menu, a field to which a file name is input to save or restore a set file, a save button and a restoration button are displayed. The save and restoration will be described later.

In setting of the above image mode, if “Television” or “Movie” is selected, “Backlight”, “Color temperature”, “RGB Drive”, the items of “Image detailed-adjustment” and “Save/restoration of set file” in the detailed menu are displayed in gray and inhibited from being selected. Furthermore, in the image mode of “Television” or “Movie”, only the items “High image quality”, “Resolution plus” (super high resolution), etc., can be selected. In the image mode of “Television” or “Movie”, in order that a television or movie be viewed as optimal images, an apparatus which supplies the television/movie sets “Backlight”, “Color temperature”, “RGB drive” and “image detailed-adjustment” of the monitor apparatus 10 to optimal values such that the values are inhibited from being changed. Also, in setting of another image mode for an image obtained by a user or the like, the items “High image quality”, “Resolution plus”, etc., are inhibited from being selected.

In block B62, if set values of the items are adjusted, they are transmitted to the monitor apparatus 10.

In the monitor apparatus 10, the system controller 28 stores the adjusted set values in the flash memory 30, and sets them in the image processing module 24 or the backlight 40. Thereby, the monitor apparatus 10 adjusts a display made due to an image signal from the image source device 11. A menu for setting values of adjustment items is displayed by the personal computer 10, not the monitor apparatus 10. Thus, the image displayed by the monitor apparatus 10 is not obstructed by the menu, and it is therefore possible to check in detail how changes of the set values are reflected in the display and to what degree the set values should be changed, and is thus possible to determine accurate set values. Each time setting of the monitor apparatus 10 is changed, set values of the monitor apparatus 10 are transmitted to the personal computer 12 (block B86). In block B88, the monitor apparatus 10 displays an image subjected to adjustment.

The set values transmitted to the personal computer 12 are displayed on the display 68 of the personal computer 12 in block B64; and also if the set values correctly reflect correction, e.g., if they are new in time, it is determined that the set values are changed (block B66). That is, if the time described in attribute information of the set values transmitted to the personal computer 12 is later than the time at which set values adjusted in block B62 were transmitted to the monitor apparatus 10, a set file of the set values transmitted to the personal computer 12 can be saved by inputting its file name in the item “Save and restoration of set file” (block B72). If it is set to save the set file, in block B74, the set file is stored in a memory device such as the SSD 58 or HDD4. In order to change settings with reference to the set items, if it is not set to save the set file, processing to be executed is returned to block B62. Also, if it is necessary to perform a detailed adjustment using a new image after saving the set file, in block B76, it is determined whether a subsequent adjustment image is present or not. In block B76, if it is determined that a new adjustment image is present, the processing is returned to block B61 to select a new image, and the processes of blocks B61 to B70 are executed.

In block B66, if the set values are not correctly received by the personal computer 12, or the set values do not correctly reflect correction, e.g., if the set values are not new in time, it is determined that the set values are not changed. If the set values are not changed, a communication channel is re-established, the processing is returned to block B61, and the processes of blocks B61 to B70 are executed.

Furthermore, in block B76, if a subsequent adjustment image is not present, processing ends in block B78.

In such a manner, the monitor apparatus 10, which has an image adjustment function and actually displays an image, communicates with the personal computer 12, which performs a menu display and an adjustment-value operation, though a network. Thus, if this communication is not correctly performed, the set values of the personal computer 12 are not correctly reflected in the image adjustment by the monitor apparatus. In view of this point, the personal computer 12 determines whether the set values are correctly changed in the monitor apparatus 10 or not. If the set values are not correctly changed, there is a possibility that communication between the monitor apparatus 10 and the personal computer 12 may not be correctly performed. Thus, a communication channel is established in block B70, and the processing is returned to block B58. If the set values are correctly changed, the set values adjusted by the personal computer 12 are reflected in the monitor apparatus 10, and it is therefore determined whether the set file should be saved or not in block B72. If it is determined that the set file should be saved, the set file transferred from the monitor apparatus 10 is saved in block B74; and if it is determined that the set file should not be saved, the processing is returned to block B62.

The items of the HTML menu in FIGS. 6A and 6B are shown merely by way of example, and can be variously modified. In addition to the items as shown in FIGS. 6A and 6B, with respect to image adjustment, the HTML menu can be made to include, for example, the items “Adjustment mode”, “Low-delay mode”, “Resolution plus setting”, “Color texture”, “brightness edge correction”, “Image (V) enhancer”, “Motion Picture Experts Group-noise reduction (MPEG-NR)”, “Dynamic-NR”, “block noise clear”, “Color edge correction”, “Brightness restoration”, “LED area control”, “Texture equalizer”, “Progressive processing”, and “Return to initial value”.

The adjustment mode is set to either “Preset” or “Custom”. It should be noted that in the adjustment mode, setting is performed independent of the image mode. “Low-delay mode” is set to either “ON” or “OFF”. “Resolution plus setting” includes the items “Gain adjustment”, “Correction level”, “Three-dimensional frame” and “Film grain restriction”. “Color texture” includes the items “Color texture”, “R gain”, “G gain” and “B gain”. “Brightness edge correction” is set to either “Automatic” or “Manual”. “V enhancer” is set to one of “Strong”, “Intermediate”, “Weak” and “OFF”. The MPEG-NR is set to “Strong”, “Intermediate”, “Weak” and “OFF”. The dynamic-NR is set to one of “Strong”, “Intermediate”, “Weak” and “OFF”. “Block noise clear” is set to one of “Strong”, “Intermediate”, “Weak” and “OFF”. “Color edge correction” is set to either “Automatic” or “Manual”. “Brightness restoration” is set to either “Automatic” or “Manual”. “LED area control” is set to one of “Strong”, “Intermediate”, “Weak” and “OFF”. “Texture realizer” is set to one of “Automatic”, “Manual” and “OFF”. “Progressive processing” is set to one of “Automatic”, “Image”, “30p” and “24p”. It should be noted that if “High image quality” is set to “OFF”, none of “Low-delay mode”, “Resolution plus setting”, “Color texture”, “Brightness edge correction”, “V enhancer”, “MPEG-NR”, “Dynamic-NR”, “Block noise clear”, “Color edge correction”, “Brightness restoration”, “LED area control”, “Texture realizer” and “Progressive processing” can be set. If “Return to initial value” is selected, set values of a presently selected image mode are all initialized.

Furthermore, main-machine setting of the monitor apparatus can be made to include the items “HDMI dual setting”, “Audio setting”, “Display port”, “RGB range”, “Input automatic switching”, “Input automatic skip”, “Input automatic skip”, “Power saving setting”, “Power saving setting”, “LED brightness setting”, “Display set orientation”, “Display set orientation”, “Screen size”, “Screen size”, “Language setting”, “Language setting”, “Network setting” and “Password setting”.

“HDMI dual setting” is set to either “Applied” or “Not applied”. “Audio setting” is set to either “HDMI 1” or “HDMI 2”. If “HDMI dual setting” is not applied, “Audio setting” cannot be set. “Display port” is set to “SST” or “MST”. “RGB range” is set to one of “Automatic”, “Full range” and “Limited range”, separate from the items “HDMI 1”, “HDMI 2”, “HDMI dual” and “DP”. “Input automatic switching” is set to either “Applied” or “Not applied”. “Input automatic skip” is set to either “Applied” or “Not applied”. “Power saving setting” is set to either “Applied” or “Not applied”. “LED brightness setting” is set to “Extinction”, “1”, “2”, “3”, “4” and “5”. “Display set orientation” is set to either “Landscape (horizontally long)” or “Portrait (vertically long)”. In 2K resolution or less, “Screen size” is set to one of “Full”, “Normal” and “Native”, and in 4K resolution, “Screen size” is set to one of “4K normal”, “4K full (left)”, “4K full (center)” and “4K full (right)”. “Language setting” is set to either “English” or “Japanese”. “Network setting” is set to one of “IP address setting”, “DNS setting”, “Proxy setting” and “MAC address”. “Password” is set to ether “User name” or “Password”.

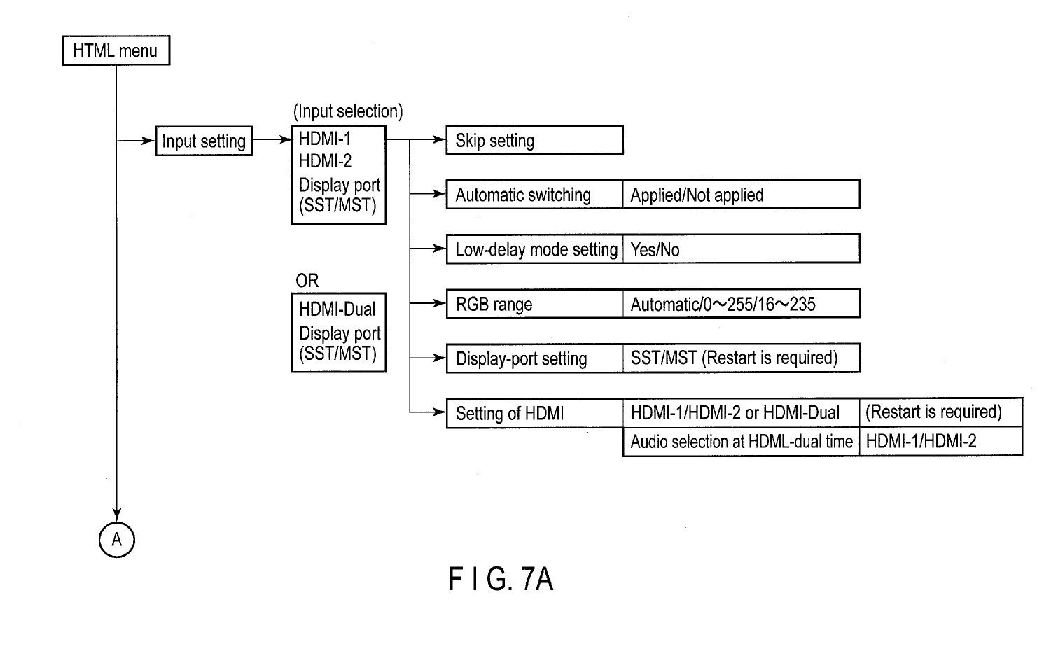

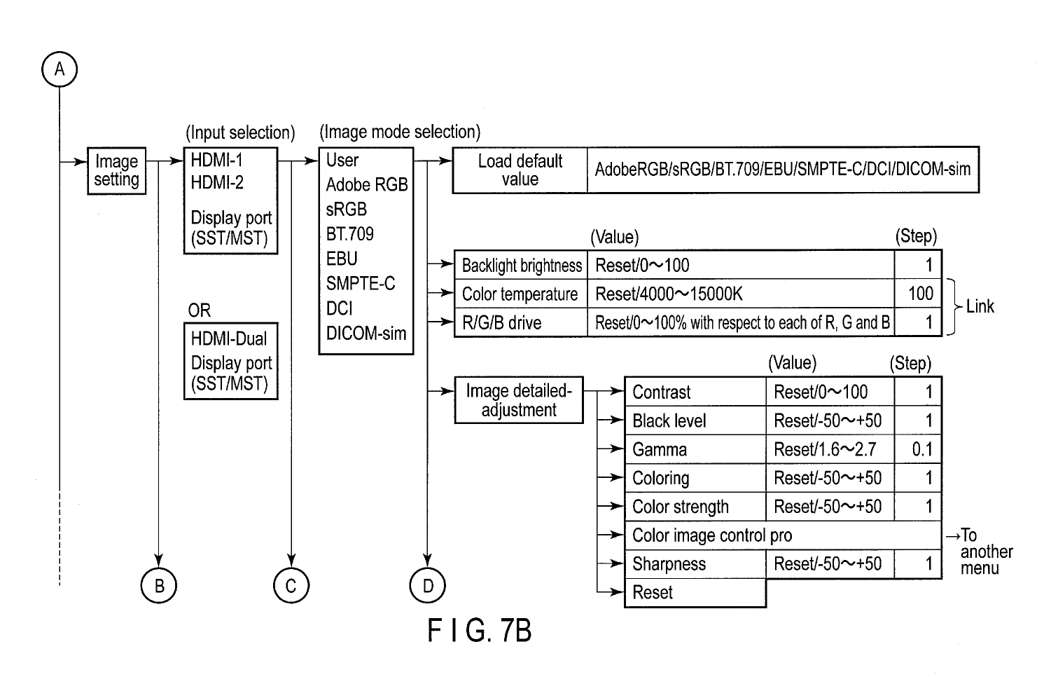

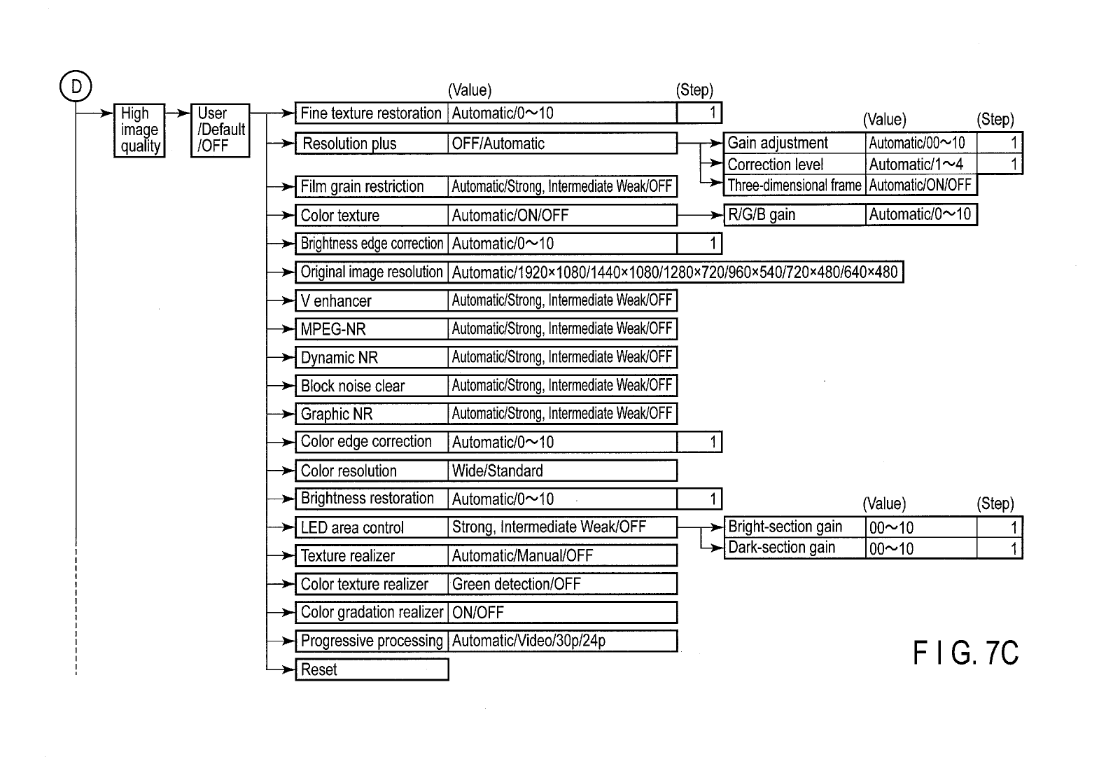

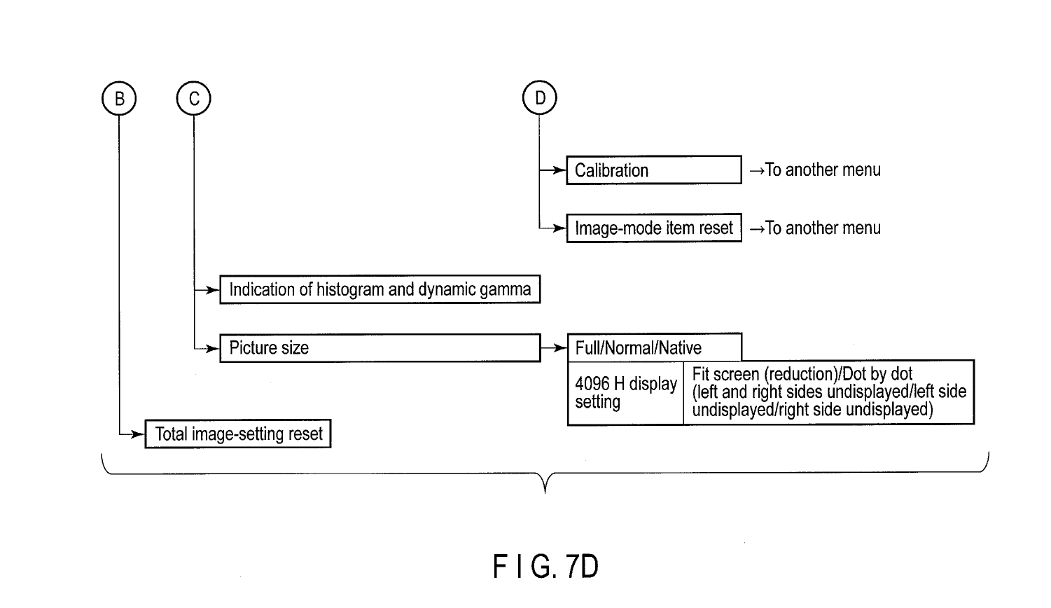

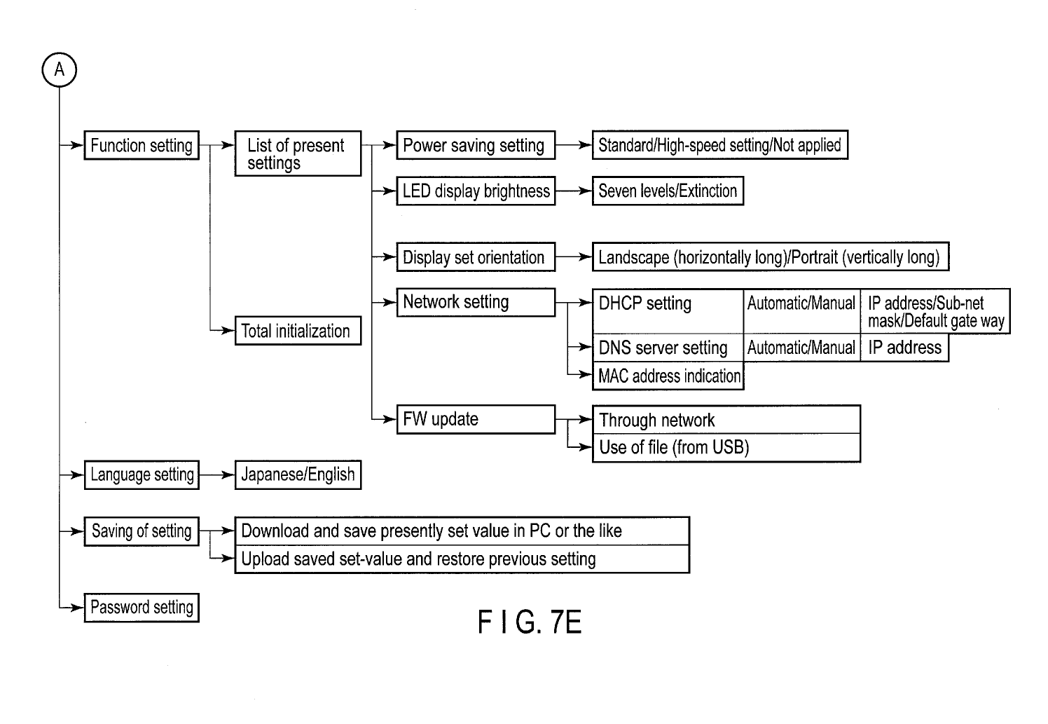

Another example of the HTML menu is shown in FIGS. 7A to 7E. In this example, an HTML menu has a hierarchical structure (in a horizontal direction in FIGS. 7A-7E), and a main menu includes the following six items: “Input setting”; “Image setting”; “Function setting”; “Language setting”; “Saving of setting”; and “Password setting”.

If the first item “Input setting” of the main menu is selected, an input selection menu is displayed. “Input setting” is set to one of “HDMI-1”, “HDMI-2”, “Display port (SST/MST)” or HDMI dual” and “Display port (SST/MST)”. If any of those inputs is selected, a menu including the setting items “Skip setting”, “Automatic switching”, “Low-delay mode setting”, “RGB range”, “Display port setting” and “HDMI” is displayed. In “Skip setting”, each of inputs which can be selected (which are not to be skipped) is selected with a radio button (with respect to each of all them, at least one initial value is selected). “Automatic setting” is set to either “Applied” or “Not applied” (i.e., whether to permit switching to another input or not in accordance with presence or absence of an input signal), and its initial value is set as “Applied”. “Low-delay mode setting” is set to either “Yes” or “No”. “Yes” corresponds to “Game mode”, and its initial value is set as “No”. “RGB range” is set to one of “Automatic”, “0-255” and “16-235”, and its initial value is set to “Automatic”. “Display port setting” is set to either “SST” or “MST” (needing restart), and its initial value is set as “SST”. If “HDMI setting” is selected, a menu including the items “HDMI-1”, “HDMI-2” and “HDMI dual” and audio selection items at HDMI dual time is displayed. Although “HDMI-1”, “HDMI-2” and “HDMI dual” require restart, if one of “HDMI-1”, “HDMI-2” and “HDMI dual” is selected and set. In “HDMI dual”, a dual screen mode is set if two ports are used, and its initial value is set to “HDMI-1” or “HDMI-2” (independent). Audio selection at an HDMI dual time is set to either “HDMI-1” or “HDMI-2”, and its initial value is set as “HDMI-1”.

If the second item “Image setting” of the main menu is selected, a menu including the items “Input setting” and “Total image-setting reset” is displayed. If “total image-setting reset” is selected, all the settings are reset. “Input setting” is set to one of “HDMI-1”, “HDMI-2”, “Display port (SST/MST) or HDMI dual” and “Display port (SST/MST)”.

If any of the above inputs is selected, a menu including the items “Image mode selection”, “Indication of histogram and dynamic gamma” and “Picture size” is displayed. If “Indication of histogram and dynamic gamma” is selected, another menu is displayed. If “Picture size” is selected, a menu having the items “Full”, “Normal”, “Native” and “4096H display setting” is displayed. The image mode is set to one of “User”, “Adobe RGB”, “sRGB”, “BT. 709”, “EBU”, “SMPTE-C”, “DCI” and “DICOM-sim”.

If the image mode is selected, a menu including the items “Load Default Value”, “backlight brightness”, “Color temperature”, “RGB Drive”, “Image detailed-adjustment”, “High image quality”, “Calibration” and “Image-mode item reset” is displayed. “Load Default Value” is provided to select an initial value of a user mode, and is set to one of “sRGB”, “BT. 709”, “EBU”, “SMPTE-C”, “DCI” and “DICOM-sim”. If the image mode is selected, “Load Default Value” and “Backlight brightness” are reset, or set to fall within the range of the range of 0 to 100 cd/m² while being changed in increments or decrements of 1 cd/cm². “Color temperature” is reset or set to fall within the range of the range of 4,000 K to 15,000 K while being changed in increments or decrements of 100 K. “RGB Drive” is reset or set to fall within the range of the range of 0 to 100% with respect to each of R, G and B while being changed in increments or decrements of 1%. “Color temperature” and “RGB Drive” are linked to each other.

If “Image detailed-adjustment” is selected, a menu including the items “Contrast”, “Black level”, “Gamma”, “Coloring”, “Color strength”, “Color image control pro”, “Sharpness” and “Reset” is displayed. “Contrast” is reset or set to fall within the range of 0 to 100 while being changed in increments and decrements of 1. “Black level” is reset or set to fall within the range of −50 to +50 while being changed in increments and decrements of 1. “Gamma” is reset or set to fall within the range of 1.6 to 2.7 while being changed in increments or decrements of 0.1. “Coloring” is reset or reset or set to fall within the range of −50 to +50 while being changed in increments or decrements of 1. “Color strength” is reset or set to fall within the range of −50 to +50 while being changed in increments or decrements of 1. If “color image control pro” is selected, another menu not shown is displayed. “Sharpness” is reset or set to fall within the range of −50 to +50 while being changed in increments or decrements of 1. If “Image-mode item reset” is selected, set values of entire detailed adjustment are reset.

If “High image quality” is selected, a mode selection menu indicating the modes “User”, “Default” and “OFF” is displayed. If any of those modes is selected, a menu including the items “Fine texture restoration”, “Resolution plus”, “Film grain restriction”, “Color texture”, “Brightness edge correction”, “Original image resolution”, “V enhancer”, “MPEG-NR”, “Dynamic NR”, “Block noise clear”, “Graphics NR”, “Color edge correction”, “Color resolution”, “Brightness restoration”, “LED area control”, “Texture realizer”, “Color texture realizer”, “Color-gradation realizer”, “Progressive processing” and “Reset” is displayed.

“Fine texture restoration” is automatically set or set to fall within the range of 0 to 100 while being changed in increments or decrements of 1. “Resolution plus” is set to either “OFF” or “automatic”. If “Automatic” is selected, “Gain adjustment”, “Correction level” and “Three-dimensional frame” are adjusted. “Gain adjustment” is automatically set or set is set to fall within the range of “00” to “10” while being changed in increments or decrements of 1. “Correction level” is automatically set or is set to fall within the range of 1 to 4 while being changed in increments or decrements of 1. “Three-dimensional frame” is set to one of “automatic”, “ON” and “OFF”.

“Film grain restriction” is set to one of “Automatic”, “Strong”, “Intermediate”, “Weak” and “OFF”. “Color texture” is set to one of “Automatic”, “ON” and “OFF”. “Brightness edge correction” is automatically set or is set to fall within the range of 0 to 10 while being changed in increments or decrements of 1. “Original image resolution” is automatically set or is set to one of “1920×1080”, “1440×1080”, “1280×720”, “960×540”, “720×480” and “640×480”. “V enhancer” is set to one of “Automatic”, “Strong”, “Intermediate”, “Weak” and “OFF”. “MPEG-NR” is set to one of “Automatic”, “Strong”, “Intermediate”, “Weak” and “OFF”. “Dynamic NR is set to one of “Automatic”, “Strong”, “Intermediate”, “Weak” and “OFF”. “Block noise clear” is set to one of “automatic”, “strong”, “Intermediate”, “Weak” and “OFF”. “Graphic NR” is set to one of “Automatic”, “Strong”, “Intermediate”, “Weak” and “OFF”. “Color edge correction” is automatically set or set to fall within the range of 0 to 10 while being changed in increments or decrements of 1. “Color resolution” is set to either “Wide” or “Standard”. “Brightness restoration” is automatically set or set to fall within the range of 0 to 10 while being changed in increments or decrements of 1. “LED area control” is set to one of “Strong”, “Intermediate”, “Weak” and “OFF”. “Texture realizer” is set to one of “Automatic”, “Manual” and “OFF”. If “Automatic” is selected, setting menus of “Bright-section gain” and “Dark-section gain” (both set to fall within the range of “00” to “10” while being changed in increments or decrement of 1) are displayed. “Color-texture realizer” is set to either “Green detection” or “OFF”. “Color-gradation realizer” is set to either “ON” or “OFF”. “Progressive processing” is set to one of “Automatic”, “Video”, “30p” and “24p”. If “Reset” is selected, an entire adjustment value of “High image quality” is reset.

If the third item “Function setting” of the main menu is selected, a menu including the items “List of present settings” and “Total initialization” is displayed. If “List of present settings” is selected, a menu including the items “Power saving setting”, “LED display brightness”, “Display set orientation”, “network setting” and “Firmware update” is displayed. “Power saving setting” is set to one of “Standard”, “High-speed start” and “Not applied”, and its initial value is set as “Standard”. In “Standard”, power consumption is lowered until a standby state is established, and in “High-speed start”, power consumption is lowered until the backlight is turned off. “LED display brightness” is setting of brightness of a green LED at the time of turning on the power supply (orange indicating standby and brightness of flashing light during starting are fixed at preset values), and is set to any of seven levels or “extinction”. “Display set orientation” is set to either “Landscape (horizontally long)” or “Portrait (vertically long)”. If “Network setting” is selected, a menu including the items “DHCP setting”, “DNS server setting” and “MAC address indication” is displayed. “Firmware update” is performed through a network or with USB. If a USB memory storing firmware is loaded into the monitor apparatus, the firmware is automatically updated.

The fourth item “Language setting” of the main menu is set to either “Japanese” or “English”.

The fifth item “Saving of setting” of the main menu is set to either “Download and save presently set value in PC or the like” or “Upload saved set-value file and restore previous setting”.

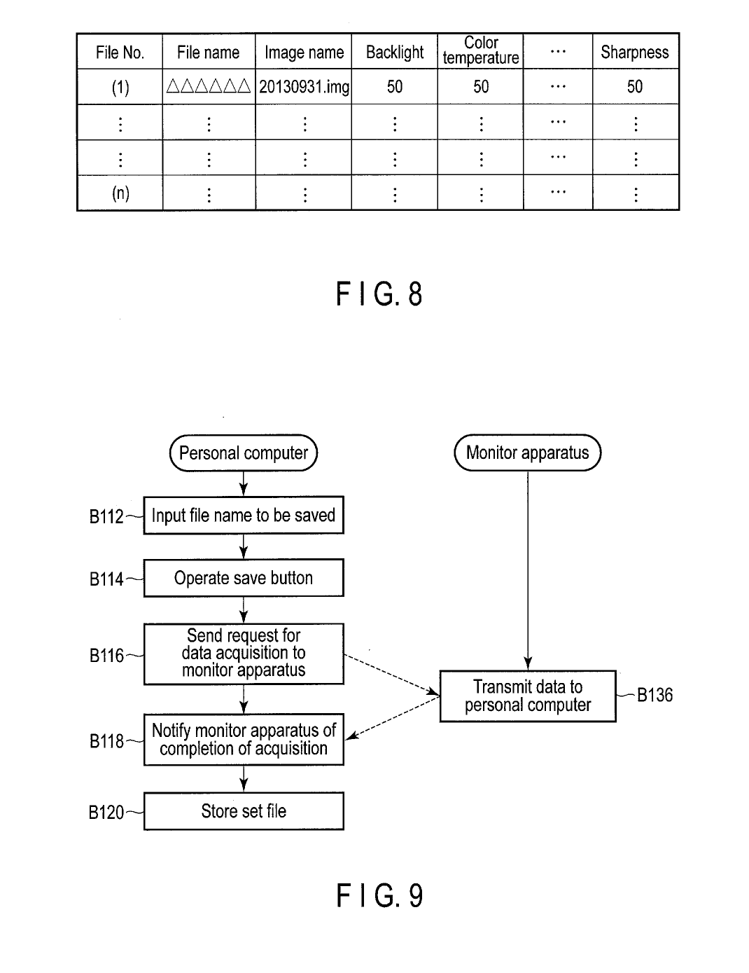

A set file which is saved in block B74, as shown in FIG. 8, is saved by way of example as a tabular file including items of a detailed menu as shown in FIGS. 6A and 6B.

To be more specific, in each of set files, parameter values set in the items of the detailed menu as shown in FIGS. 6A and 6B are stored in addition to a file number, a file name and an image name to be referred to in detailed setting, and files (1)-(n) are stored in such a tabular manner as shown in FIG. 8 such that they can be referred to, and files (1) and (2) are displayed.

Referring to a flowchart shown in FIG. 5, each time a set value is changed, it is confirmed in step B72 whether to store such a detailed set file as shown in FIG. 8 or not. However, it may be set that a user specifies the time at which saving should be performed, and such a detailed set file as shown in FIG. 8 is stored with an interrupt operation.

A flow of an interrupt operation and saving of such a detailed set file as shown in FIG. 8 will be explained with reference to FIG. 9.

Based on the menu as shown in FIGS. 6A and 6B, sliders are slid to adjust set values of the adjustment items to desired values, and such a detailed set file as shown in FIG. 8 in which the desired set values are associated with an image to be adjusted is saved in the personal computer 12. As a result, in the case of adjusting a similar image, adjustment items can be set simply by reading the saved value, i.e., without adjusting the adjustment items one by one, and setting the read values in the monitor apparatus 10.

If the desired set values are determined, the user of the personal computer 12 inputs a file name of a file to be saved, to a filename input field in the menu (FIGS. 6A and 6B) in block B112, and taps a save button in block B114. In block B116, the personal computer 12 sends a request for data acquisition to the monitor apparatus 10. Upon receipt of the request, the monitor apparatus 10 transmits data to the personal computer 12 in block B136. Also upon receipt of the data, the personal computer 12 notifies the monitor apparatus 10 of completion of the acquisition in block B118, and stores the data in the SSD 58 or HDD as such a detailed set file as shown in FIG. 8, which has the file name input in block B114, in block B120.

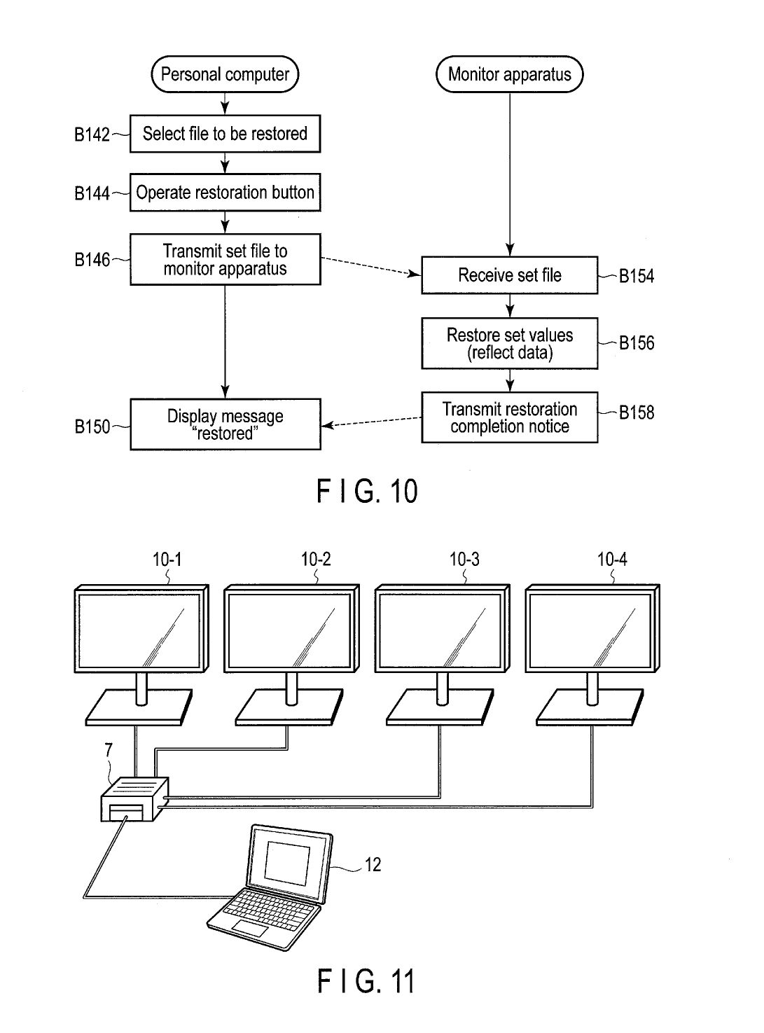

Next, a flow of restoration of the set file will be explained with reference to FIG. 10.

In the case where an image name is specified by referring to the detailed set file as shown in FIG. 8 and an associated image is re-displayed by the monitor apparatus, an image adjusted with parameters set in the detailed set file as shown in FIG. 8 can be displayed. In this case, the monitor to be used to display the above adjusted image is not limited to the monitor apparatus 10; that is, the adjusted image can be displayed by a plurality of monitor apparatuses 10-1 to 10-4 as shown in FIG. 11.

To be more specific, an image signal is output from the personal computer 12 to one or more monitor apparatuses 10-1 to 10-4 through an allotter 7, and at the same time, the detailed set file is output to one or more monitor apparatuses 10, to thereby enable an image adjusted with the same set parameters to be displayed by one or more monitor apparatuses 10. Therefore, one or more monitor apparatuses 10 can display the adjusted image set by the user in the same state, as a result of which it is possible to save time and trouble which would be required and given if the monitor apparatuses 10 are each adjusted, and also possible to cause an image whose quality is maintained as that of an art work to be displayed on any of the monitor apparatuses 10.

In restoration of an image in the monitor apparatus 10, as shown in FIG. 10, first, the user of the personal computer 12 inputs a file name of a file to be read, to the file name field of the menu (FIGS. 6A and 6B) in block B142, and taps the restoration button in block B144. The personal computer 12 reads a set file whose file name is specified, from the SSD 58 or HDD, and transmits the set file to the monitor apparatus 10 through the wireless LANs 6-1 and 6-2 (block B146). In this transmission or before the transmission, an image described in the set file is output from the personal computer 12 or another apparatus to the monitor apparatus 10 through cables such as HDMI cables 16 and 17. The monitor apparatus 10 receives the set file in block B154, and sets (restores) a set value of the image processing module 24 and a set value of the backlight 40 in accordance with the set file in block B156. In block B158, the monitor apparatus 10 transmits a restoration completion notice to the personal computer 12, and upon receipt of the restoration completion notice, in block B150, the personal computer 12 displays the message “restored” in some part of the menu, and ends processing.

Thereby, image adjustment can be re-achieved in the same adjustment items and adjustment values as in those previously selected and set, without re-selecting adjustment items and re-setting adjustment values.

Furthermore, with file data having a format as shown in FIG. 8, images associated with files (1)-(n) are automatically reproduced and displayed in setting adjusted and set in detail on the monitor apparatus 10. In automatic reproduction, when image data is transferred from the personal computer 12 to the monitor apparatus 1, the files (1)-(n) set in detail are transmitted with reference to a file name of the image data to the monitor apparatus 10, and images are sequentially reproduced in accordance with the detailed adjustment setting. To be more specific, in block B142, restoration files are selected in a reproduction order, and also, in accordance with the reproduction order, the order of reproduction of images (which is specified by file numbers) and reproduction time are set. Then, in block B144, if the restoration button is pressed, as indicated in block B146, the image data and the files (1)-(n) set in detail are transmitted to the monitor apparatus 10. Therefore, the monitor apparatus 10 receives the set file in block B154, and sets (restores) the set value of the image processing module 24 and that of the backlight 40 in accordance with the set file in block B156. Thereafter, in block B158, the monitor apparatus 10 sends the restoration completion notice to the personal computer 12, and upon receipt of the restoration completion notice, in block B150, the personal computer 12 display a “completion of restoration of automatic display” message in some part of the menu, and ends processing.

As explained above, according to the first embodiment, an electronic apparatus having a web browser is connected to a monitor apparatus which performs image adjustment, through a network; and a menu image for image adjustment is transmitted from the monitor apparatus to the electronic apparatus, and displayed by the electronic apparatus. The user can select an adjustment item or items on the menu image displayed by the electronic apparatus, and set values of the adjustment items. The set values are transmitted to the monitor apparatus, and image adjustment is performed by the monitor apparatus based on the adjustment values set in the menu image. Therefore, it is possible to solve the following problems of a conventional method in which values of adjustment items are set using buttons of a main body of the monitor apparatus or those of a remote control while viewing a menu displayed by the monitor apparatus with OSD, and also possible to set accurate set values in a short time. In the conventional method, the menu is superimposed on an image, and it is therefore hard to confirm how the image is adjusted; and it is also hard to perform an operation with the buttons. Those problems, as described above, are solved by the first embodiment. In the conventional method, in order to accurately confirm how adjustment is reflected in the image, it is necessary to dismiss the menu each time such a confirmation is made, and the operation is troublesome. In the first embodiment, setting can be performed while viewing an entire image displayed by the monitor apparatus. Accordingly, it is possible to finely confirm how adjustment is reflected in the image. In addition, the WEB browser can be more easily operated than the buttons, thus improving the convenience of the user.

The electronic apparatus has only to include a web browser; that is, it is not necessary to install a specific application on the electronic apparatus. Thus, a notebook or tablet computer owned by the user can be applied; that is, it is not necessary to prepare a specific remote control or apparatus manufactured at a high cost. Furthermore, the electronic apparatus includes a larger display as a remote control, and also input interfaces such as a mouse, a keyboard and a touch panel. Therefore, even if settings are complicated, their contents can be displayed by the electronic apparatus, thus enabling inputting and operation to be easily performed. Although the monitor apparatus and the personal computer need to be connected to each other through LAN, it can be achieved at a low cost to provide a cable or wireless LAN interface at the monitor apparatus.

Moreover, once values are set, they can be saved in a file in the personal computer. Thus, in the case of setting adjustment values for an image identical or similar to a previous one, setting whose values are saved can be easily restored simply by reading the file, and setting of the adjustment values can be performed in a short time. Also, in the case of displaying an image signal identical to a previous one, on the monitor apparatus, it is possible to easily achieve the same setting as in the previous image signal.

It should be noted that since the processing according to the first embodiment can be achieved with a computer program, it is possible to easily obtain the same advantages as in the first embodiment simply by installing a computer-readable storage medium storing the computer program onto a computer.

The present invention is not limited to the embodiments described above but the constituent elements of the invention can be modified in various manners without departing from the spirit and scope of the invention. Various inventions can be made by appropriately combining a plurality of constituent elements disclosed in the embodiments. For example, some constituent elements may be deleted from all the constituent elements disclosed in the embodiments. Constituent elements described in different embodiments may be combined as appropriate.

What is claimed is:

1. A display apparatus comprising:
an input module which inputs an image signal from outside;
a display module which display an image based on the image signal;
an image adjustment module which adjusts the image displayed by the display module;
a storage module which stores a first menu and a second menu, each of which is to be superimposed on the image in response to a display instruction which instructs the image adjustment module to display an adjustment menu,
wherein the first menu includes a first group of an adjustment item and an adjustment value, the second menu includes a second group of a display item and an adjustment value, the second group of the display item includes at least the first group of the adjustment item, the second group of the adjustment value includes at least the first group of the adjustment value, and the second menu is stored as a menu file made in markup language in the storage module;
a transmitter-receiver which transmits the menu file from the storage module to an external electronic apparatus in response to a transfer request from the outside of the display apparatus, and receives a response file from the external electronic apparatus based on transmission of the menu file, wherein the response file includes the set display adjustment item and the adjustment value set in the second menu; and
a controller which causes the image adjustment module to adjust the image in accordance with the set display adjustment item and the adjustment value included in the response file.

2. The display apparatus of claim 1, wherein the controller controls adjustment of the image, which is performed in accordance with the set display adjustment item and the adjustment value, and also causes the display module to display the image by dismissing the first menu superimposed on the image.

3. The display apparatus of claim 1, wherein
the first menu includes an IP address which specifies the display apparatus, the transfer request from outside being transmitted based on the IP address, and
the replay file includes a file name, an image name, the set display adjustment item and the set adjustment value.

4. The display apparatus of claim 1, wherein each of the first and second group adjustment item includes an image input, an image mode, an adjustment mode, a color temperature and a backlight.

5. A method of displaying a display of a display apparatus, comprising:
inputting an image signal from outside to cause a display module to display an image;
superimposing a first menu on the image in response to a display instruction to display an adjustment menu, the first menu including a first group of adjustment item and an adjustment value;
transmitting a menu file to an external electronic apparatus in response to a transfer request from the outside of the display apparatus, wherein the menu file is made in markup language to indicate a second menu including a second group of a display adjustment item and an adjustment value, the second group of the display item includes at least the first group of the adjustment item, and the second group of the adjustment value includes at least the first group of adjustment value;
receiving a response file from the external electronic apparatus based on transmission of the menu file, wherein the response file includes the set display adjustment item and the adjustment value set in the second menu; and
adjusting the image in accordance with the set display adjustment item and the adjustment value in the response file.

6. The method of claim 5, wherein before the image is adjusted in accordance with the set display adjustment item and adjustment value, the display module is caused to display the image only by dismissing the first menu superimposed on the image.

7. An electronic apparatus connectable to a display apparatus which comprises an image adjustment module which adjusts a displayed image, and a storage module which stores a first menu and a second menu, the first menu including a first group of an adjustment item and an adjustment value, the second menu including a second group of an adjustment item and an adjustment value and being also stored as a file made in markup language, the electronic apparatus comprising:
a reception module which receives the file from the display apparatus;
a display module which displays the second menu based on the file received by the reception module;
a transmission module which transmits the adjustment value set based on the second group of the adjustment item and the adjustment value included in the second menu, as a response file, to the display apparatus, and causes the image adjustment module to adjust the image in accordance with the set display adjustment item and the set adjustment value; and
a storage module which stores the set display adjustment item and the set adjustment value in association with the image associated with the image displayed by the display module.

8. The electronic apparatus of claim 7, further comprising:
a module which inputs an IP address of the display apparatus; and
a module which sets connection to the IP address.

9. A method in an electronic apparatus connectable to an image display apparatus (1) which comprises an image adjustment module and a storage module which stores a first menu and a second menu, the first menu including a first group of an adjustment item and an adjustment value, the second menu including a second group of an adjustment item and an adjustment value and being also stored as a file made in markup language, the method comprising:
receiving the file from the display apparatus;
displaying the menu based on the received file;
transmitting the adjustment value set based on the second group of adjustment item and the adjustment value included in the menu, as a response file, to the display apparatus, and causing the image adjustment module to adjust the image in accordance with the set display adjustment item and the set adjustment value.

10. A program to be executed by a computer in an electronic apparatus connectable to an image adjustment module and a storage module which stores a first menu and a second menu, the first menu including a first group of an adjustment item and an adjustment value, the second menu including a second group of an adjustment item and an adjustment value and being also stored as a file made in markup language, the program comprising:
receiving the file from the display apparatus;
displaying the second menu based on the received file;
transmitting the adjustment value set based on the second group of the adjustment item and the adjustment value included in the menu, as a response file, to the display apparatus, and causing the image adjustment module to adjust the image in accordance with the set display adjustment item and the set adjustment value.
